(19) United States
(12) Patent Application Publication
(10) Pub. No.: US 2020/0389936 A1
(43) Pub. Date: Dec. 10, 2020

(54) INFORMATION MANAGEMENT APPARATUS AND TERMINAL APPARATUS

(71) Applicant: FUJI XEROX CO., LTD., Tokyo (JP)

(72) Inventor: Shinichiro YAMAMOTO, Kanagawa (JP)

(73) Assignee: FUJI XEROX CO., LTD., Tokyo (JP)

(21) Appl. No.: 16/731,048

(22) Filed: Dec. 31, 2019

(30) Foreign Application Priority Data
Jun. 5, 2019 (JP) 2019-105125

(51) Int. Cl. H04W 88/06; H04W 88/04; H04W 76/11; H04W 4/80; H04W 12/08; H04W 8/22

(52) U.S. Cl. CPC H04W 88/06; H04W 88/04; H04W 8/22; H04W 4/80; H04W 12/0808; H04W 76/11

(57) ABSTRACT

An information management apparatus includes a storage unit that stores identification information of a terminal apparatus and data acquired from the terminal apparatus in association with each other, a first communication unit that communicates with the terminal apparatus by a first communication method for transmitting and receiving data through a base station of a mobile phone communication network, a second communication unit that performs communication by a second communication method having a larger amount of data communicable than the first communication unit, a first data acquisition unit that acquires, from the terminal apparatus, data including first data acquired by the terminal apparatus and the identification information of the terminal apparatus, using the first communication unit, and an instruction transmission unit that transmits to the terminal apparatus, an instruction to transmit the data using the second communication method, in a case where a change occurs in the first data acquired by the first data acquisition unit.

### CROSS-REFERENCE TO RELATED APPLICATIONS

This application is based on and claims priority under 35 USC 119 from Japanese Patent Application No. 2019-105125 filed Jun. 5, 2019.

### BACKGROUND

### (i) Technical Field

The present invention relates to an information management apparatus and a terminal apparatus.

### (ii) Related Art

JP2003-110751A discloses that in a case where a terminal apparatus transmits data to an information management apparatus, mobile phone communication or Internet communication is selected for data transmission, based on the type and capacity of the data. Specifically, for the purpose of providing a portable information device and a line switching method which have a wireless telephone function and realize low-cost, high-speed wireless communication, a mobile phone performs switching so as to selectively use one of a wireless telephone line or a wireless LAN line. It is possible to set the prohibition of reception of data sent through the wireless telephone line, or to set the wireless LAN line to be used preferentially in a case of data transmission. By using the wireless LAN line in a case of communication with information equipment on the company private line, communication cost can be reduced by the system on the company side, there are few types of media that are involved in data transfer, and a high transfer rate can be realized.

### SUMMARY

Aspects of non-limiting embodiments of the present disclosure relate to an information management apparatus and a terminal apparatus, which enable an information management apparatus to acquire data from a terminal apparatus through a more convenient communication path, for the information management apparatus to handle data acquired from the terminal apparatus, as compared to a case where an information management apparatus receives data from a terminal apparatus through a data communication path determined based on the determination made on the terminal apparatus side.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

The gist of the present invention for achieving the object lies in the following inventions.

According to an aspect of the present disclosure, there is provided an information management apparatus including: a storage unit that stores identification information of a terminal apparatus and data acquired from the terminal apparatus in association with each other; a first communication unit that communicates with the terminal apparatus by a first communication method for transmitting and receiving data through a base station of a mobile phone communication network; a second communication unit that performs communication by a second communication method having a larger amount of data communicable than the first communication unit; a first data acquisition unit that acquires, from the terminal apparatus, data including first data acquired by the terminal apparatus and the identification information of the terminal apparatus, using the first communication unit; and an instruction transmission unit that transmits to the terminal apparatus, an instruction to transmit the data using the second communication method, in a case where a change occurs in the first data acquired by the first data acquisition unit.

### BRIEF DESCRIPTION OF THE DRAWINGS

Exemplary embodiment (s) of the present invention will be described in detail based on the following figures, wherein:

FIG. 1 is a conceptual module configuration diagram for a configuration example of the present exemplary embodiment (information management apparatus);

FIG. 2 is a conceptual module configuration diagram for a configuration example of the present exemplary embodiment (terminal apparatus);

FIG. 3 is a diagram illustrating a system configuration example using the present exemplary embodiment;

FIG. 4 is a flowchart illustrating a process example according to the present exemplary embodiment;

FIG. 5 is an explanatory diagram showing a data structure example of transmission data;

FIGS. 6A and 6B are explanatory diagrams showing a data structure example of a user-terminal apparatus correspondence table;

FIG. 7 is an explanatory diagram showing a data structure example of a user management table;

FIG. 8 is an explanatory diagram showing a data structure example of a terminal apparatus-position correspondence table;

FIG. 9 is an explanatory diagram showing a data structure example of a user-measurement data correspondence table;

FIG. 10 is an explanatory diagram showing a data structure example of an instruction information table;

FIG. 11 is an explanatory diagram showing a data structure example of device data;

FIG. 12 is a flowchart illustrating a process example according to the present exemplary embodiment;

FIG. 13 is an explanatory diagram showing a data structure example of a relay device-position correspondence table;

FIG. 14 is an explanatory diagram showing a data structure example of a relay device-terminal apparatus pair management table;

FIG. 15 is a flowchart illustrating a process example according to the present exemplary embodiment;

FIG. 16 is a flowchart illustrating a process example according to the present exemplary embodiment;

FIG. 17 is an explanatory diagram showing a process example using Modification Example 1 of the present exemplary embodiment;

FIG. 18 is an explanatory diagram showing a process example using Modification Example 2 of the present exemplary embodiment;

FIG. 19 is a block diagram showing a hardware configuration example of a computer that implements the present exemplary embodiment (relay device); and

FIG. 20 is a block diagram showing a hardware configuration example of a computer that implements the present exemplary embodiment (information management apparatus).

### DETAILED DESCRIPTION

Hereinafter, with reference to the drawings, a description will be made of an exemplary embodiment for realizing the invention.

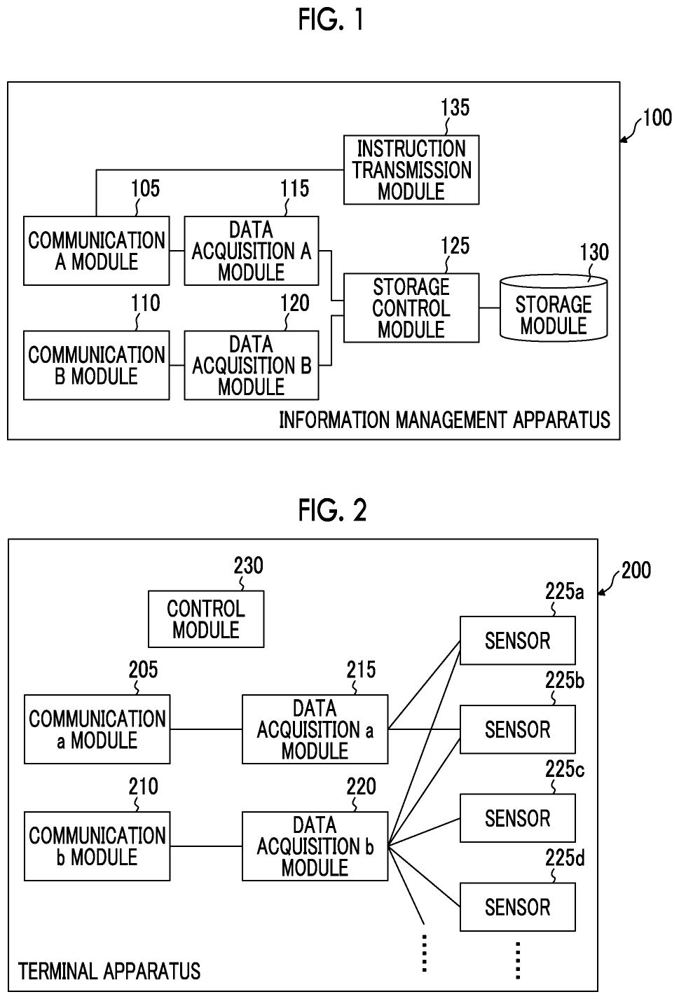

FIG. 1 is a conceptual module configuration diagram for a configuration example of an information management apparatus 100 which is the present exemplary embodiment.

The module generally indicates components such as software (including a computer program as an interpretation of “software”) or hardware which may be logically divided. Therefore, the module in the present exemplary embodiment indicates not only a module in a computer program but also a module in a hardware configuration. Therefore, in the present exemplary embodiment, a description will also be made of a computer program (for example, a program causing a computer to execute each procedure, a program causing a computer to function as each means, or a program a computer to realize each function), a system, and a method for functioning as such a module. However, for convenience of description, “storing”, “being stored”, or words equivalent thereto are used, but, these words indicate that a storage device stores data or a storage device is controlled to store data in a case where an exemplary embodiment is a computer program. A module may correspond to a function on a one-to-one basis, and, in installation, a single module may be configured with a single program, a plurality of modules may be configured with a single program, and, conversely, a single module may be configured with a plurality of programs. The plurality of modules may be executed by a single computer, and a single module may be executed by a plurality of computers in a distributed or parallel environment. Other modules may be included in a single module. Hereinafter, the term “connection” indicates not only physical connection but also logical connection (for example, transmission and reception of data, an instruction, a reference relationship between pieces of data, login, and the like). The term “being predetermined” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “a plurality of predetermined values”, the values may be different from each other, and two or more values may be the same as each other (“two or more values”, of course, include all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where the plurality of computers, pieces of hardware, and apparatuses are configured to be connected to each other via communication means such as a network (“network” includes communication connection on a one-to-one basis) but also a case of being configured with a single computer, a single piece of hardware, and a single apparatus. The “apparatus” and the “system” are used as terms having an identical meaning. Of course, the “system” does not include systems that are merely a social “mechanism” (that is, social system) which is an artificial arrangement.

Target information is read from a storage device, the process is performed, and a process result is written to the storage device for each process performed by each module or for each process in a case where a plurality of processes are performed in a module. Therefore, description of reading for a storage device before a process and writing for the storage device after the process will be omitted. The storage device here may include a hard disk drive, a random access memory (RAM, for short), an external storage medium, a storage device connected via a communication line, a register in a central processing unit (CPU, for short), or the like.

In recent years, as wide-area communication means for an information management apparatus to acquire data from IoT equipment, various low power and wide area (LPWA, for short) communication standards enabling communication at lower power consumption and lower bit rate than current mobile phone communication have been proposed.

As LPWA, SIGFOX (registered trademark), LoRa (registered trademark), Wi-Fi HaLow, Wi-SUN, NB-IoT, and the like are known, and all are a wireless access communication method that covers a range that cannot be met with near field communication (up to about several tens of meters) such as Bluetooth (registered trademark). All of these have a narrow communication bandwidth, and are characterized by low power consumption, low bit rate, and wide area coverage.

The information management apparatus 100 according to the present exemplary embodiment has a function of acquiring data transmitted from the terminal apparatus 200 and managing the data. As shown in the example of FIG. 1, the information management apparatus 100 includes a communication A module 105, a communication B module 110, a data acquisition A module 115, a data acquisition B module 120, a storage control module 125, a storage module 130, and an instruction transmission module 135.

Between the information management apparatus 100 and the terminal apparatus 200, communication can be performed by either (1) a communication method A through a base station of a mobile phone communication network or (2) a communication method B capable of performing communication through a relay device and the Internet. In such a communication environment, the information management apparatus 100 may want to instruct the terminal apparatus 200 to perform any communication. That is, the data is acquired from the terminal apparatus 200 through a communication path convenient for the information management apparatus 100 to handle the data acquired by the terminal apparatus 200.

The information management apparatus 100 according to the present exemplary embodiment instructs the terminal apparatus 200 to change from the communication method A to the communication method B. Conversely, the information management apparatus 100 instructs the terminal apparatus 200 to change the communication method from the communication method B to the communication method A.

Note that, the communication method A is LPWA, and the communication method B is communication using the Internet, and is transmission to the information management apparatus 100 relayed by the edge server. As an example of the communication method A, NB-IoT, particularly NIDD will be described below.

The communication A module 105 is connected to the data acquisition A module 115 and the instruction transmission module 135. The communication A module 105 has a function of communicating with the other party through the base station in a communication procedure in mobile phone communication between the terminal apparatus 200 and the base station of the mobile phone communication network. In this communication procedure, there are a first data area that is a fixed-length data area and a second data area that is used in data communication after establishing communication in the communication procedure and is a variable-length area corresponding to data transmitted. In general, the first data area is a data area used for controlling the communication procedure such that the base station manages the position of the terminal apparatus 200, the base station detects a call from the terminal apparatus 200, or the base station makes a connection request to the terminal apparatus 200, by exchanging communication between the base station and the terminal apparatus 200. In the present exemplary embodiment, out of a first data area that is a fixed-length data area used in the communication procedure in the mobile phone communication between the terminal apparatus 200 and the base station of the mobile phone communication network and a second data area that is used in data communication after establishing communication in the communication procedure and is a variable-length area corresponding to data transmitted, data acquired by the terminal apparatus 200 is included in the first data area, and communication is performed using a mode in which data is transmitted and received through the base station using a communication method for transmitting and receiving data only in the first data area.

The “first data area” herein is used in the communication procedure of mobile phone communication, and is a fixed-length area that includes control information. For example, a control plane (C-plane) corresponds to mobile phone communication. The “second data area” is a data area other than the fixed-length area of the control information used in the communication procedure described above, a variable-length data area for storing data to be transmitted, after communication is established by the communication procedure, and an area that contains data used by users. This data area is an area prepared for data to be transmitted, and is an area that has an upper limit but is prepared for a larger amount of data than the first data area. For example, in mobile phone communication, a user plane (U-plane) containing voice data and packet data corresponds thereto.

The “communication method performed by the communication A module 105” operates in a mode in which data is transmitted and received only in the first data area, and basically does not use the second data area for transmission and reception.

This communication method is a fixed-length data communication with a small amount of data used only in the communication procedure. Since the communication bandwidth is small and there is a few data transmission and reception procedures, communication is possible with low power consumption and can be provided at a lower cost than the communication method of mobile phone communication using the second data area where variable and large communication bandwidth needs to be prepared.

A specific example of this communication method is non-IP data delivery (NIDD, for short) communication.

Note that, there are at least two or more areas in the data handled in the mobile phone communication between the terminal apparatus 200 and the base station of the mobile phone communication network, the first data area among the areas is for a data amount smaller than the data amount of the second data area, which is the another area, and the communication A module 105 may perform communication by selecting a mode in which the data acquired by the terminal apparatus 200 is included in the first data area, and data is transmitted and received through the base station using a communication method for transmitting and receiving data only in the first data area, or a mode in which data acquired by the terminal apparatus 200 is included in the second data area and communication is performed by the communication method using the first data area and the second data area. The communication A module 105 can transmit and receive data to and from the terminal apparatus 200 in both directions.

The communication B module 110 is connected to the data acquisition B module 120. The communication B module 110 communicates with the terminal apparatus 200 through a relay device connected to a communication line protected by a firewall and the Internet. In the communication between the relay device and the communication B module 110, the relay device is connected to a communication line protected by a firewall, so data can be transmitted from the relay device to the communication B module 110 and acquired by the data acquisition B module. On the other hand, in a case where data is spontaneously transmitted from the communication B module 110 to the relay device, the firewall does not accept this data transmission, and so-called push communication from the communication B module 110 to the relay device cannot be performed. Regarding communication in response to communication in which an access request is made to the information management apparatus 100 from the relay device through the firewall, the firewall can pass data from the communication B module.

The data acquisition A module 115 is connected to the communication A module 105 and the storage control module 125. The data acquisition A module 115 acquires data including the first data acquired by the terminal apparatus 200 and the identification information of the terminal apparatus 200 from the terminal apparatus 200 using the communication A module 105.

The data acquisition B module 120 is connected to the communication B module 110 and the storage control module 125. The data acquisition B module 120 acquires data including the second data acquired by the terminal apparatus 200 and the identification information of the terminal apparatus 200 from the terminal apparatus 200 connected to the communication line protected by the firewall, using the communication B module 110.

The storage control module 125 is connected to the data acquisition A module 115, the data acquisition B module 120, and the storage module 130. The storage control module 125 controls the storage module 130 to store the data acquired by the data acquisition A module 115 or the data acquisition B module 120. In detail, “data acquired by the data acquisition A module 115 or the data acquisition B module 120” is data including the first data acquired by the data acquisition A module 115 and the identification information of the terminal apparatus 200, or data including the second data acquired by the data acquisition B module 120 and the identification information of the terminal apparatus 200.

The storage module 130 is connected to the storage control module 125. The storage module 130 stores the identification information of the terminal apparatus 200 and the data acquired from the terminal apparatus 200 in association with each other.

The instruction transmission module 135 is connected to the communication A module 105. The instruction transmission module 135 transmits instruction information for instructing to perform communication through the relay device from communication through the base station, to the terminal apparatus 200, using the communication A module 105. That is, the instruction transmission module 135 instructs the terminal apparatus 200 to change from the communication method A to the communication method B. The communication method A is used for communication in this case.

The second data acquired using the communication B module 110 may have a larger data amount than the first data. The instruction transmission module 135 may transmit instruction information for changing from the communication method A to the communication method B, in a case where it is necessary to acquire more detailed data than the first data. Since the second data is assumed to have more data types, more detailed data, or a larger amount of data than the first data, for example, it is desirable to change to the communication method B that enables a wider communication bandwidth and a higher communication rate than the communication method A characterized by a narrow communication bandwidth, low power consumption, and low bit rate.

The instruction information may include information indicating the type of information as the second data to be acquired by the terminal apparatus 200.

Further, in addition to the type of information included in the first data, the instruction information may include information indicating a type different from the type. That is, different types of data are transmitted. For example, this corresponds to a case where the terminal apparatus 200 includes a heart rate sensor, acquires a heart rate as the first data, and additionally acquires electrocardiogram information and body temperature information from sensors.

The instruction information may include information indicating an interval at which the terminal apparatus 200 acquires data. The acquisition interval is shortened. For example, this corresponds to a case where the heart rate which has been measured once every hour is measured every minute.

The instruction information may include information indicating an interval of data transmission by the terminal apparatus 200. The communication method is changed from the communication method A to the communication method B, and the communication interval is shortened. For example, this corresponds to a case where data which has been transmitted once a day is transmitted hourly.

Further, the instruction information may include information related to the relay device with which the terminal apparatus 200 is to communicate. Here, “information on the relay device” is information for the terminal apparatus 200 to connect to the relay device, and includes, for example, the address of the relay device.

Even in a case where there are a plurality of relay devices in the vicinity of the terminal apparatus 200, and connection requests are received from the plurality of relay devices for the terminal apparatus 200 to connect to the relay device, an appropriate relay device can be selected.

In this case, in a case where there are a plurality of relay devices in the vicinity of the terminal apparatus 200, the instruction transmission module 135 may include in the instruction information, information on the relay device with a small number of terminal apparatuses 200 that are already communicating.

In addition, the instruction information may include the address of the information management apparatus 100 in a case of performing communication through the Internet.

Since it is assumed that the terminal apparatus 200 knows the address of the information management apparatus in the mobile phone communication network, but does not know the address (for example, uniform resource locator (URL, for short)) of the information management apparatus 100 in the Internet according to the communication method B of the communication B module 110, it is necessary to inform the address.

However, in a case where the relay device knows the address of the information management apparatus 100 in advance, the relay device may transmit the address to the terminal apparatus 200. In that case, it is not necessary to include the address of the information management apparatus 100 in the instruction information.

The instruction transmission module 135 may transmit the instruction information, in a case where the first data acquired by the data acquisition A module 115 changes under a predetermined condition.

The “predetermined condition” may be a case where the amount of data transmitted by the terminal apparatus 200 increases compared to the previous communication.

Here, the “amount of data transmitted” is the amount of data transmitted within a predetermined period. The amount of data transmitted may be the amount of data received by the information management apparatus 100. The terminal apparatus 200 may transmit, to the information management apparatus 100, the amount of data transmitted. For example, the information management apparatus 100 may detect that data to be transmitted by the terminal apparatus 200 is increasing. Note that, the cause of the increase of the communication quantity may include a case where the communication state of the mobile phone communication network is poor and data to be transmitted at a time increases.

Further, the “predetermined condition” may be a case where the first data acquired by the data acquisition A module 115 is set to exceed a predetermined threshold.

For example, a case where a predetermined threshold is exceeded due to a sharp rise in the heart rate, or the like is applicable. In addition, a case where the normal value of the heart rate, for example, the average value of the heart rate of the user in the past predetermined period managed by the information management apparatus 100 is set as the normal value, and the difference between the normal value and the value acquired this time exceeds a predetermined threshold is applicable.

Further, the “predetermined condition” may be a case where the first data acquired by the data acquisition A module 115 changes in a predetermined pattern.

For example, abnormalities in data contents are detected in a case where the heart rate changes up and down in a short period of time.

Further, in a case where the second data acquired by the data acquisition B module 120 no longer meets the above-described predetermined condition, the instruction transmission module 135 may transmit change information for changing from communication through the relay device for performing data communication with more details or a large amount of data to communication through the base station for performing communication with normal data amount, for example. That is, the communication method is changed from the communication method B to the communication method A.

In addition, in the case of “in a case where the above-described predetermined condition is no longer met”, it may be added that a predetermined period has elapsed since the condition is no longer met.

Further, the “predetermined condition” may be a case where the acquisition interval of the first data by the data acquisition A module 115 is longer than the previous acquisition interval.

Since it is assumed that the communication state of the mobile phone communication network deteriorates, in a case where the communication state deteriorates, it is instructed to use the relay device and the Internet without using the communication path of the mobile phone communication network. Specifically, the communication interval in communication method A is stored as a log, and in a case where the interval is longer than the communication interval in the past (past includes immediately before), communication method is changed from the communication method A to the communication method B. However, in this case, the data acquired by the data acquisition B module 120 remains the first data (so-called normal data).

Further, the storage module 130 may store the identification information of the terminal apparatus 200 and the information of the user of the terminal apparatus 200 in association with each other.

Then, in a case where the second data cannot be acquired by the data acquisition B module 120, the instruction transmission module 135 may notify the user corresponding to the identification information of the terminal apparatus 200.

Specifically, in a case where the instruction transmission module 135 receives information from the terminal apparatus 200 that communication through the relay device is impossible, the instruction transmission module 135 may notify the user corresponding to the identification information of the terminal apparatus 200.

In addition, in a case where the communication by the communication B module 110 is impossible, the instruction transmission module 135 may notify the user corresponding to the identification information of the terminal apparatus 200.

FIG. 2 shows a conceptual module configuration diagram for a configuration example of the terminal apparatus 200 which is the present exemplary embodiment.

The terminal apparatus 200 includes a communication a module 205, a communication b module 210, a data acquisition a module 215, a data acquisition b module 220, a sensor 225a, a sensor 225b, a sensor 225c, a sensor 225d, and a control module 230.

The terminal apparatus 200 has at least two communication means (communication method A through a base station and communication method B through a relay device), acquires data from various sensors 225, and transmits the data to the information management apparatus 100 by any communication means. For example, the terminal apparatus 200 includes what is called an IoT terminal. Specifically, examples are a portable information communication device (as a portable information communication device, including mobile phones, smartphones, mobile devices, wearable computers, or the like) that can detect information on the human body (also referred to as biological information, more specifically, body temperature, heart rate information, electrocardiogram information, body temperature information, or the like), communication devices with sensors (thermo-hygrometers, strain gauges, or the like) that detect a state of building (temperature, humidity, strain of buildings such as bridges), and communication devices with sensors (thermo-hygrometers, weather sensors, or the like) that detect weather information (temperature, humidity, pressure, brightness, ultraviolet rays, noise, or the like).

The communication a module 205 is connected to the data acquisition a module 215. There are at least two or more areas in the data handled in the mobile phone communication between the terminal apparatus 200 and the base station of the mobile phone communication network, the first data area among the areas is for a data amount smaller than the data amount of the second data area, which is the another area, and the communication a module 205 receives and transmits data with the information management apparatus 100 outside a firewall, by using a communication method in which the data acquired by the terminal apparatus 200 is included in the first data area, and data is transmitted and received only in the first data area, through the base station.

The communication b module 210 is connected to the data acquisition b module 220. The communication b module 210 performs near field communication with a relay device in the firewall. The communication b module 210 communicates with the information management apparatus 100 through the relay device. Examples of near field communication include Bluetooth and Wi-Fi. Specifically, there are Bluetooth Low Energy (BLE, for short), Wi-Fi-Direct, and the like.

In a case where communication is started by the communication b module 210, information including identification information of the terminal apparatus 200 may be transmitted and communication with the relay device that has received the information may be established.

The data acquisition a module 215 is connected to the communication a module 205, the sensor 225a, and the sensor 225b. The data acquisition a module 215 acquires data from the sensor 225. Then, the acquired data is transmitted to the information management apparatus 100 through the communication a module 205.

The data acquisition b module 220 is connected to the communication b module 210, the sensor 225a, the sensor 225b, the sensor 225c, and the sensor 225d. The data acquisition b module 220 acquires more data than the data acquired by the data acquisition a module 215. Then, the acquired data is transmitted to the information management apparatus 100 through the communication b module 210. As described above, according to the instruction in the instruction information transmitted from the information management apparatus 100, for example, data may be acquired from more sensors 225 than the sensors 225 from which the data acquisition a module 215 acquires data, and data may be acquired from the sensor 225 at an interval shorter than the interval at which the data acquisition a module 215 acquires data. Data may be transmitted to the information management apparatus 100 through the communication b module 210 at an interval shorter than the interval at which the data acquisition a module 215 transmits data to the information management apparatus 100 through the communication a module 205.

The sensor 225 is connected to the data acquisition a module 215 and the data acquisition b module 220. The sensor 225 detects the state of the target (the concept of measurement may be included in the detection), and passes the detection result to the data acquisition a module 215 or the data acquisition b module 220. As described above, information on the human body may be detected, the state of the building may be detected, or weather information may be detected. One or more sensors 225 may be provided. Examples of the sensor 225 that detects information on the human body include a heart rate sensor, a body temperature sensor, an electroencephalogram sensor, and a pulse oximeter.

In a case where the data acquired by the data acquisition a module 215 from the sensor 225 is transmitted to the information management apparatus 100 using the communication a module 205, and the instruction information instructing the communication a module 205 to perform communication through the relay device from communication through the base station is received, the control module 230 performs control such that the data acquired by the data acquisition b module 220 transmits data to the information management apparatus 100 using the communication b module 210.

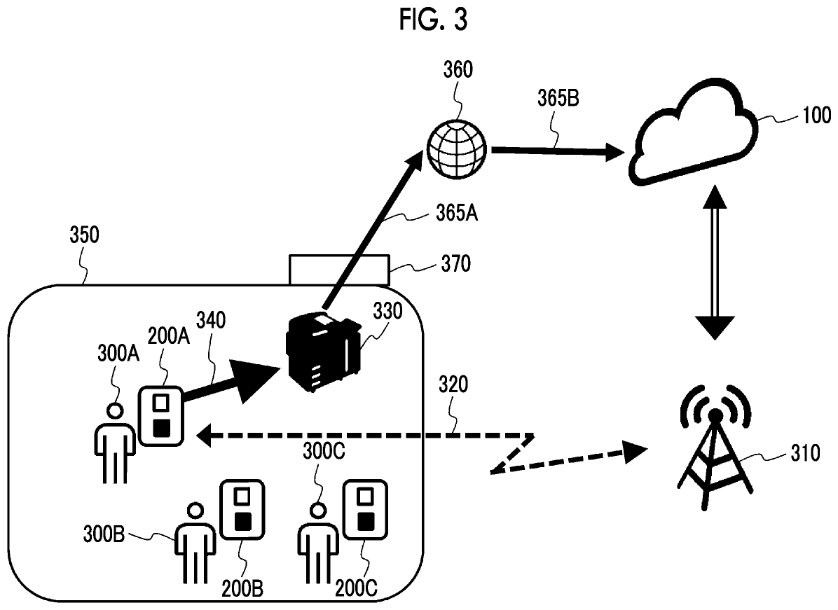

FIG. 3 is a diagram illustrating a system configuration example using the present exemplary embodiment.

FIG. 3 shows an example in which the terminal apparatus 200 shown in FIG. 2 is worn by each user 300 and is a wearable computer which detects information on the human body of the user 300. An example assuming a so-called health management service is shown. The terminal apparatus 200 is also called an IoT device.

The base 350 corresponds to a room in a company or the like, for example. For example, there is a user 300 who is an employee. The user 300 is generally a plurality of users, but may be a single user.

A relay device 330 is installed in the base 350. The relay device 330 has a so-called edge server function. For example, a printer, a multifunction peripheral (an image processing apparatus having any two or more functions of a scanner, a printer, a copier, a fax machine, or the like) or the like may incorporate a relay device. The relay device 330 relays communication between the terminal apparatus 200 and the information management apparatus 100 through the firewall 370 and the Internet 360. Near field communication 340 is used for communication between the terminal apparatus 200 and the relay device 330, and Internet communication 365 is used for communication between the relay device 330 and the information management apparatus 100. The relay device 330 is in the firewall 370. That is, communication from the relay device 330 to the information management apparatus 100 is possible, but communication from the information management apparatus 100 to the relay device 330 is restricted.

Further, it is assumed that the user 300 is within a range where the relay device 330 can perform the near field communication 340. That is, it is assumed that the relay device 330 and the terminal apparatus 200 can communicate with each other. The near field communication 340 is an example of communication performed by the communication b module 210 described above, and the Internet communication 365 is an example of communication performed by the communication B module 110 described above.

The information management apparatus 100 has a function as a management server for information on the human body. Of course, the functions of the information management apparatus 100 may be realized as a cloud service. For example, poor physical condition, fatigue, and the like of the user 300 are detected using the heart rate information of the user 300, and a message that alerts the user 300 or another person (for example, a boss) may be notified using e-mail or the like.

The base station 310 is also referred to as a mobile base station, and may be a base station 310 of a telecommunications carrier of a communication carrier system or a so-called unique base station 310 other than a telecommunications carrier. The terminal apparatus 200 communicates with the base station 310 by the LPWA communication 320. The LPWA communication 320 is a public line and is used for periodic notification and transmission of a small amount of data. The LPWA communication 320 is an example of communication performed by the communication A module 105 and the communication a module 205 described above. The base station 310 and the information management apparatus 100 may perform communication using the Internet communication 365 or may perform communication using a telephone line. Examples of the LPWA communication 320 include, specifically, NIDD communication. Only the “control plane” that controls the communication of the mobile phone protocol is used. That is, the “user plane” of voice data and packet data is not used. In the NIDD communication, no IP is required, the SIM of the terminal apparatus 200 is identified by the IMSI information, the communication data amount is small, the power consumption is low, and only the control plane is used, so it is possible to provide a service at a very low price (may include free service).

At normal times, the terminal apparatus 200 communicates with the base station 310 by the LPWA communication 320 to transmit information on the human body of the user 300 to the information management apparatus 100. Note that, the normal time refers to a state in which the information management apparatus 100 has not detected health abnormalities of the user 300. That is, it is a state where it is determined that it is not necessary to acquire detailed data from the terminal apparatus 200. Hereinafter, it is also referred to as a normal mode.

The information management apparatus 100 analyzes the data from the terminal apparatus 200 transmitted through the base station 310, and instructs the terminal apparatus 200 to transmit detailed data, in a case of detecting health abnormalities of the user 300. Hereinafter, it is also referred to as a detailed data acquisition mode. This instruction is performed by communication of the LPWA communication 320 through the base station 310. Examples of “health abnormalities” include that the physical condition has suddenly changed, high overtime continues, and there is an abnormal value in the health check result. Note that “the physical condition has suddenly changed” may be determined by the data acquired by the information management apparatus 100 in the normal mode. “High overtime continues” may be determined from the overtime data acquired by the information management apparatus 100 from the attendance management apparatus that manages the attendance of the user 300. “There is an abnormal value in the health check result” may be determined from data acquired by the information management apparatus 100 from the health management apparatus that manages the health check result of the user 300. The detailed data has a larger data amount than the data in the normal mode, and is not used for the LPWA communication 320. Therefore, the information management apparatus 100 instructs the terminal apparatus 200 to perform communication through the relay device 330 and the Internet 360.

In accordance with this instruction, the terminal apparatus 200 detects detailed data, establishes communication by the near field communication 340 with the relay device 330, and transmits the detailed data to the information management apparatus 100 through the relay device 330. That is, the Internet communication 365 is used for a large amount of data or continuous transmission of data when the situation changes.

In a case where the information management apparatus 100 analyzes detailed data transmitted from the terminal apparatus 200 through the relay device 330 and the Internet 360, and detects health abnormalities of the user 300, as described above, the information management apparatus 100 notifies the user 300 or another person of a message, using an e-mail or the like.

Conversely, in a case where the information management apparatus 100 determines that the measurement data of the user 300 is normal, the information management apparatus 100 instructs the terminal apparatus 200 to change from the detailed data acquisition mode to the normal mode. This instruction is performed by communication of the LPWA communication 320 through the base station 310. Further, in the LPWA communication 320, the terminal apparatus 200 and the information management apparatus 100 can communicate bidirectionally. The Internet communication 365 is basically one-way communication from the terminal apparatus 200 to the information management apparatus 100 because the Internet communication 365 passes through the firewall 370.

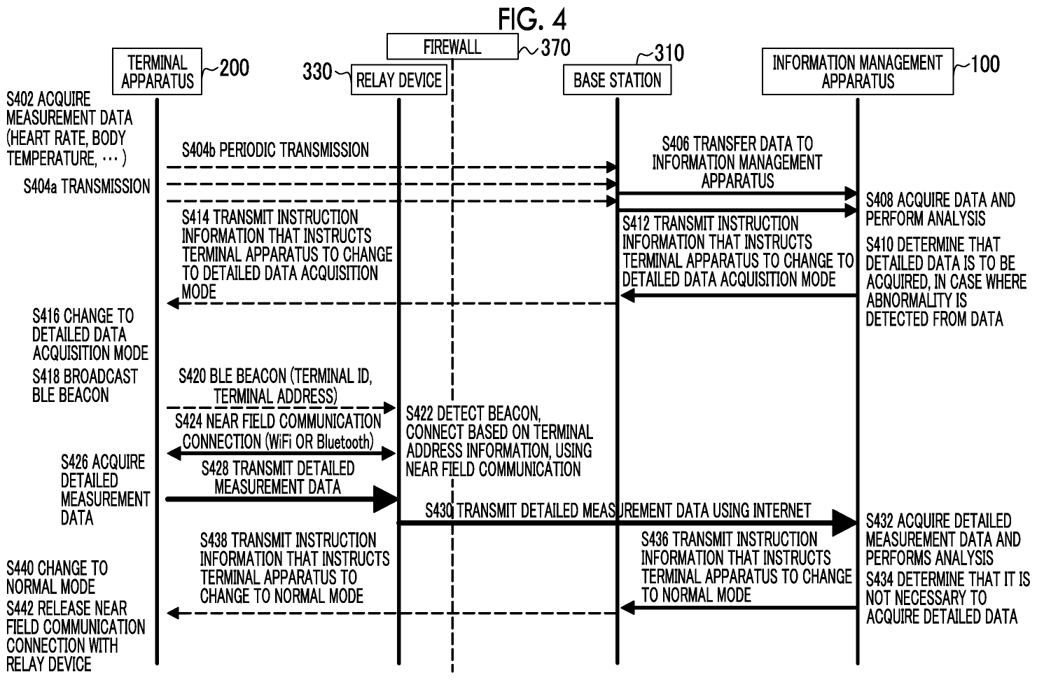

FIG. 4 is a flowchart illustrating a process example according to the present exemplary embodiment. A process example by the terminal apparatus 200, the relay device 330, the base station 310, and the information management apparatus 100 is mainly shown. Note that, the firewall 370 is interposed between the relay device 330 and the information management apparatus 100 as shown in the example of FIG. 3. The LPWA communication 320 will be described by taking NIDD communication as an example.

In step S402, the terminal apparatus 200 acquires measurement data. Specifically, the terminal apparatus 200 measures biological data such as heart rate and body temperature, and accumulates the measured data.

In step S404a, the terminal apparatus 200 transmits data to the base station 310. Specifically, the terminal apparatus 200 transmits the accumulated measurement data using NIDD communication (portable public line network).

In step S404b, the terminal apparatus 200 periodically transmits data to the base station 310. Here, the interval of the periodic transmission is, for example, once to several times a day. The heart rate and body temperature are measured at predetermined intervals (for example, every 10 minutes, every hour, or the like). As the data to be transmitted, for example, transmission data 500 including a terminal ID and measurement data is used.

In step S406, the base station 310 transfers the data received from the terminal apparatus 200 to the information management apparatus 100. Specifically, the base station 310 receives the measurement data transmitted from the terminal apparatus 200 together with the terminal ID. Then, the base station 310 transfers the received terminal ID and measurement data to the information management apparatus 100.

In step S408, the information management apparatus 100 acquires data, and performs analysis. Specifically, the information management apparatus 100 receives the terminal ID and measurement data transferred from the base station 310. Then, the received data is analyzed. As an analysis example, an analysis is performed on whether there is no change from a normal state or whether a unique pattern is shown.

In step S410, the information management apparatus 100 determines that detailed data is to be acquired, in a case where an abnormality is detected from the data. That is, it is determined that the target terminal apparatus 200 is changed from the normal mode to the detailed data acquisition mode.

Specifically, when the information management apparatus 100 detects an abnormality from the measurement data, the information management apparatus 100, it is determined that it is necessary to acquire more detailed data than the data acquired in the normal mode (specifically, data having more amount, data other than the data acquired in the normal mode, and data with high acquisition frequency).

At this time, since the amount of data is too large to acquire by NIDD communication, it is determined that it is necessary to communicate using communication means other than NIDD communication.

As an example of detailed data, heart rate data every 30 seconds may be continuously acquired, or data other than the data acquired in the normal mode may be acquired. For example, it may also be instructed to acquire electrocardiogram data, body temperature, respiratory rate, blood pressure and the like.

In step S412, the information management apparatus 100 transmits to the base station 310, instruction information that instructs the terminal apparatus 200 to change to the detailed data acquisition mode. Specifically, the information management apparatus 100 transmits to the terminal apparatus 200 “change to the detailed data acquisition mode and instruction information for data transmission using the near field communication 340”.

In step S414, the base station 310 transmits to the terminal apparatus 200, instruction information that instructs the change to the detailed data acquisition mode. Specifically, the base station 310 uses the public line network to make a call to the terminal apparatus 200, and in a case where communication is established, the base station 310 transmits the instruction information to the terminal apparatus 200.

In step S416, the terminal apparatus 200 changes from the normal mode to the detailed data acquisition mode. Specifically, the terminal apparatus 200 switches from the normal mode to the detailed data measurement mode, and performs control to transmit the measured data using the near field communication 340. The detailed data is data for which the accuracy of measuring data is increased, the measurement frequency is increased, and more pieces of information are acquired.

In step S418, the terminal apparatus 200 broadcasts a BLE beacon to find the relay device 330.

In step S420, the terminal apparatus 200 transmits a BLE beacon (terminal ID, terminal address) to the relay device 330.

Specifically, the terminal apparatus 200 switches the communication line from NIDD to near field communication 340. For this purpose, a BLE beacon is broadcast. The beacon advertisement packet includes identification information of the terminal apparatus 200 and information for connection (address and passcode).

In step S422, the relay device 330 detects a beacon from the terminal apparatus 200 and connects to the terminal apparatus 200, based on the terminal address information of the terminal apparatus 200, using near field communication. Specifically, the relay device 330 detects a BLE beacon. Based on the identification information of the terminal apparatus 200, a connection request is made to the terminal apparatus 200. The connection may be made by Bluetooth, or WiFi-Direct connection may be made based on the address included in the BLE packet. A process of performing one-to-one near field communication 340 with the terminal apparatus 200 is performed.

In step S424, near field communication connection (WiFi or Bluetooth) is performed between the terminal apparatus 200 and the relay device 330. Specifically, near field communication is established between the relay device 330 and the terminal apparatus 200. The relay device 330 activates the measurement data collection application of the terminal apparatus 200.

In step S426, the terminal apparatus 200 acquires detailed measurement data.

In step S428, the terminal apparatus 200 transmits the detailed measurement data to the relay device 330.

Specifically, the terminal apparatus 200 transmits the acquired detailed measurement data to the relay device 330 using the near field communication 340.

The near field communication 340 may maintain a communication state, and may sequentially transmit the detailed data acquired by the terminal apparatus 200, or may transmit detailed data accumulated for a predetermined period each time.

In step S430, the relay device 330 transmits detailed measurement data to the information management apparatus 100 using the Internet. Specifically, the relay device 330 uploads the detailed measurement data received from the terminal apparatus 200, to the information management apparatus 100 through the Internet 360. Alternatively, in a case where there is an information management apparatus 100 in the company, the measurement data is transmitted to the information management apparatus 100 through an internal LAN (including an intranet). Note that the internal LAN is included in the Internet as a communication infrastructure.

In step S432, the information management apparatus 100 acquires detailed measurement data uploaded by the relay device 330, and performs analysis.

In step S434, in a case where the information management apparatus 100 determines that the data is normal as a result of the analysis, the information management apparatus 100 determines that it is not necessary to acquire detailed data. Specifically, this corresponds to a case where necessary data can be acquired or a case where the state returns to a calm state and monitoring of detailed data becomes unnecessary.

In a case where the information management apparatus 100 detects health abnormalities of the user 300 as a result of the analysis, the information management apparatus 100 notifies the user 300 of a message that calls attention by using an e-mail or the like.

In step S436, the information management apparatus 100 transmits to the base station 310, instruction information that instructs the terminal apparatus 200 to change from the detailed data acquisition mode to the normal mode.

Specifically, the information management apparatus 100 transmits to the terminal apparatus 200, an instruction “change to normal mode”. That is, the instruction “change to normal mode” is transmitted from the base station 310 to the terminal apparatus 200 through the NIDD communication path.

In step S438, the base station 310 transmits to the terminal apparatus 200, instruction information that instructs the change to the normal mode.

In step S440, the terminal apparatus 200 changes to the normal mode.

In step S442, the terminal apparatus 200 releases the near field communication connection with the relay device 330. Thereafter, the processes of step S402 and step S404 are performed.

Specifically, in a case of receiving the instruction information, the terminal apparatus 200 changes to the normal mode and releases the near field communication between the relay device 330 and the terminal apparatus 200.

Note that, in a case where the terminal apparatus 200 and the relay device 330 connect to each other, the information management apparatus 100 may recognize that the connection has been established. For this purpose, the following processing may be performed.

In steps S418 to S422, the terminal apparatus 200 transmits a beacon, and the relay device 330 detects the beacon and acquires the identification information of the terminal apparatus 200.

In step S422, the relay device 330 notifies the information management apparatus 100 of the acquired identification information of the terminal apparatus 200. At this time, identification information or an address of the relay device 330 may be included.

In a case of receiving the notification from the relay device 330, the information management apparatus 100 determines that communication can be performed from the terminal apparatus 200 through the relay device 330, and transmits instruction information for instructing the terminal apparatus 200 to change to the detailed data acquisition mode, using NIDD communication. At this time, identification information or an address of the relay device 330 may be included.

The terminal apparatus 200 starts a connection with the relay device 330 using the instruction information received from the information management apparatus 100 as a trigger. At this time, the connection may be reliably performed using the identification information or address of the relay device 330.

In a case where the information management apparatus 100 cannot receive data that is to be transmitted from the relay device 330, the information management apparatus 100 determines that the relay device 330 does not exist near the terminal apparatus 200 or that the connection with the relay device 330 has failed, and may perform the following processing.
Use NIDD communication to stop the transition to the detailed data acquisition mode or transmit an instruction to change to the normal mode.
E-mail notification to the user 300 wearing the terminal apparatus 200. The contents of the e-mail are such as “Move to a place where the relay device 330 is located” or “Report physical condition to ∘∘ by e-mail or phone”.

The terminal apparatus 200 transmits, for example, transmission data 500 to the information management apparatus 100 using the LPWA communication 320.

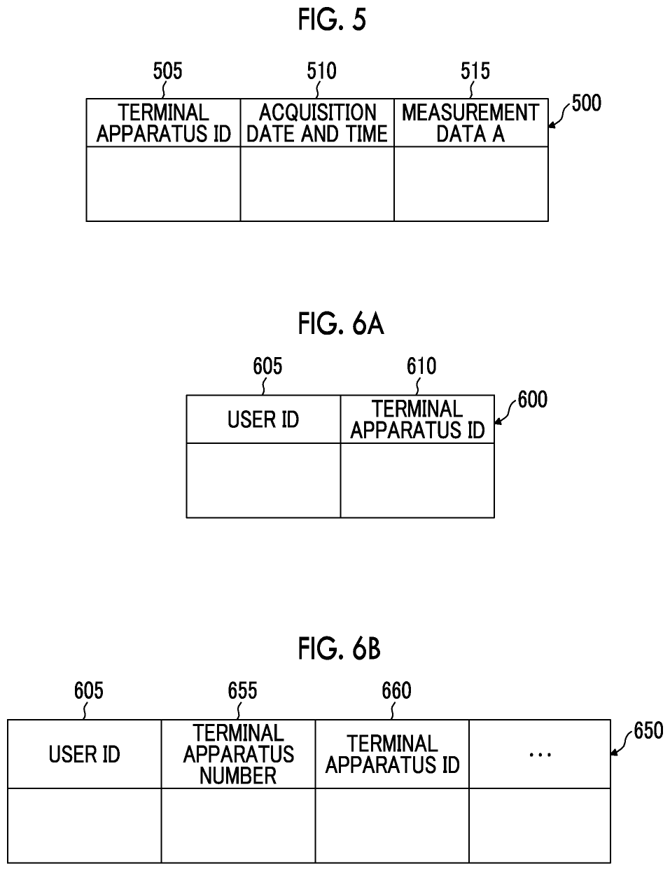

FIG. 5 is an explanatory diagram showing a data structure example of the transmission data 500. The transmission data 500 has a terminal apparatus ID field 505, an acquisition date and time field 510, and a measurement data A field 515. The terminal apparatus ID field 505 stores information (specifically, terminal apparatus identification (ID)) for uniquely identifying the terminal apparatus 200 in the present exemplary embodiment. The acquisition date and time field 510 stores the date and time (year, month, day, hour, minute, second, second or less, or a combination thereof) when data is measured. The measurement data A field 515 stores measurement data A.

In the storage module 130 of the information management apparatus 100, the transmission data 500 received from the terminal apparatus 200, a user-terminal apparatus correspondence table 600 or a user-terminal apparatus correspondence table 650, a user management table 700, a terminal apparatus-position correspondence table 800, a user-measurement data correspondence table 900, and the like are stored, and processing of steps S408, S410, S432, and S434 is performed.

The user-terminal apparatus correspondence table 600 or the user-terminal apparatus correspondence table 650 is a table for managing the correspondence between the user 300 and the terminal apparatus 200. Thereby, the data acquired from the terminal apparatus 200 can be recognized as data indicating the physical condition of who (user 300), and the physical condition of the user 300 can be managed.

FIG. 6A is an explanatory diagram showing a data structure example of the user-terminal apparatus correspondence table 600. The user-terminal apparatus correspondence table 600 has a user ID field 605 and a terminal apparatus ID field 610. The user ID field 605 stores information (specifically, a user ID) for uniquely identifying the user 300, in the present exemplary embodiment. The terminal apparatus ID field 610 stores the terminal apparatus ID of the terminal apparatus 200 worn by the user 300.

In a case where the user 300 is wearing a plurality of terminal apparatuses 200, the user-terminal apparatus correspondence table 650 may be used.

FIG. 6B is an explanatory diagram showing a data structure example of the user-terminal apparatus correspondence table 650. The user-terminal apparatus correspondence table 650 includes a user ID field 605, a terminal apparatus number field 655, a terminal apparatus ID field 660, and the like. The user ID field 605 stores a user ID. The terminal apparatus number field 655 stores the number of terminal apparatuses 200 worn by the user 300. By this number, the terminal apparatus ID field 660 follows the terminal apparatus number field 655. The terminal apparatus ID field 660 stores the terminal apparatus ID that the user 300 is wearing.

The user management table 700 is a table for managing the terminal apparatus 200 and the notification destination. The contact destination in a case where the health abnormality of the user 300 is detected is managed.

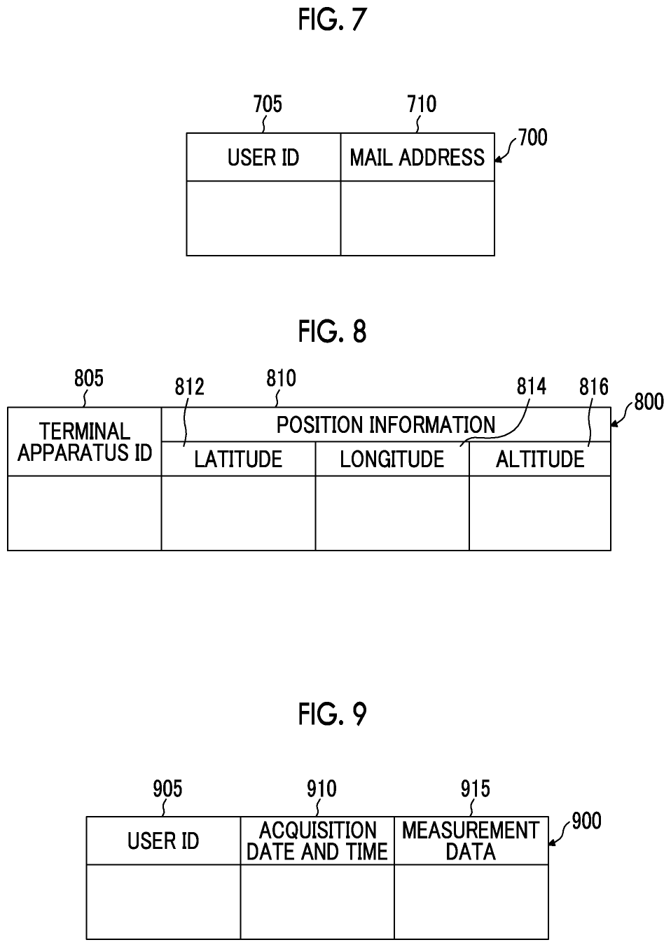

FIG. 7 is an explanatory diagram showing a data structure example of the user management table 700. The user management table 700 has a user ID field 705 and a mail address field 710. The user ID field 705 stores a user ID. The mail address field 710 stores the mail address of the user 300. Note that, the address is not limited to a mail address, and any address that can be notified to the user may be used. For example, chatting, an electronic bulletin board, and social networking service (SNS) have communication functions, push notifications, phone calls by automatic voice response, or the like. For example, Lync (registered trademark) or the like may be used as a phone call. Further, not only the address of the user 300 but also the address of a boss or a family may be registered as a contact destination at the time of abnormality.

The terminal apparatus-position correspondence table 800 is a table for managing the position of the terminal apparatus 200. That is, the terminal apparatus-position correspondence table 800 is also a table for managing the position of the user 300. The terminal apparatus-position correspondence table 800 may be used in order to search for the relay device 330 close to the user 300 in distance. Note that, the terminal apparatus 200 and the relay device 330 form a pair of the near field communication 340 through steps S420, S422, and S424, and thus the terminal apparatus-position correspondence table 800 is not necessarily required.

FIG. 8 is an explanatory diagram showing a data structure example of the terminal apparatus-position correspondence table 800. The terminal apparatus-position correspondence table 800 includes a terminal apparatus ID field 805 and a position information field 810. The position information field 810 includes a latitude field 812, a longitude field 814, and an altitude field 816. The terminal apparatus ID field 805 stores a terminal apparatus ID. The position information field 810 stores position information of the terminal apparatus 200. The latitude field 812 stores latitude. The longitude field 814 stores longitude. The altitude field 816 stores the altitude. As the position information, for example, GPS information may be acquired from the terminal apparatus 200 (or a portable information terminal such as a smartphone that the user 300 has).

The information management apparatus 100 analyzes the health state of the user 300 using the user-measurement data correspondence table 900.

FIG. 9 is an explanatory diagram showing a data structure example of the user-measurement data correspondence table 900. The user-measurement data correspondence table 900 is generated by the transmission data 500 acquired from the terminal apparatus 200, the user-terminal apparatus correspondence table 600, or the user-terminal apparatus correspondence table 650. The user-measurement data correspondence table 900 has a user ID field 905, an acquisition date and time field 910, and a measurement data field 915. The user ID field 905 stores a user ID. The acquisition date and time field 910 stores the date and time when the measurement data of the user 300 is acquired. The measurement data field 915 stores measurement data for the user 300.

The information management apparatus 100 transmits the instruction information table 1000 to the terminal apparatus 200, in a case of changing from the normal mode to the detailed data acquisition mode (or in a case of changing from the detailed data acquisition mode to the normal mode). The instruction information table 1000 is an example of instruction information.

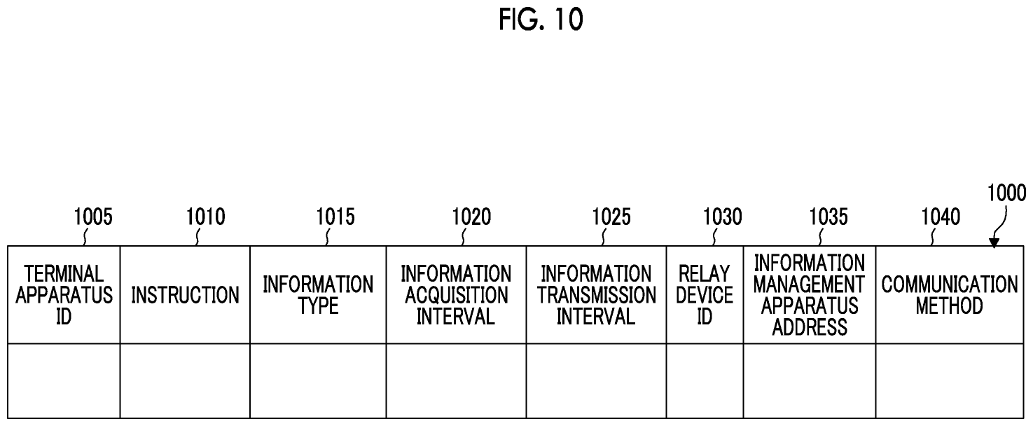

FIG. 10 is an explanatory diagram showing a data structure example of the instruction information table 1000. The instruction information table 1000 includes a terminal apparatus ID field 1005, an instruction field 1010, an information type field 1015, an information acquisition interval field 1020, an information transmission interval field 1025, a relay device ID field 1030, an information management apparatus address field 1035, and a communication method field 1040. The terminal apparatus ID field 1005 sets the terminal apparatus ID of the terminal apparatus 200 that is the instruction destination. The instruction field 1010 sets an instruction. In the instruction field 1010, for example, either (1) an instruction to change from the normal mode to the detailed data acquisition mode or (2) an instruction to change from the detailed data acquisition mode to the normal mode is set. The information type field 1015 sets the information type to be acquired by the terminal apparatus 200. After the mode is changed, the types of data to be acquired by the terminal apparatus 200 may be designated. For example, the data is heart rate, electrocardiogram information, body temperature information, and the like. More specifically, information designating the sensor 225 may be used. The information acquisition interval field 1020 sets the data acquisition interval after the mode is changed. That is, the interval detected by the sensor 225 may be set. Different data acquisition intervals may be set for each information type. The information transmission interval field 1025 sets an interval for transmitting data to the information management apparatus 100 after the mode is changed. In the present exemplary embodiment, the relay device ID field 1030 sets information (specifically, relay device ID) for uniquely identifying the relay device. That is, in the case of an instruction to change from the normal mode to the detailed data acquisition mode, the terminal apparatus 200 designates the relay device 330 to perform near field communication 340. The information management apparatus address field 1035 sets the address of the information management apparatus 100. Specifically, the URL of the information management apparatus 100 is set in a case where the instruction is an instruction to change from the normal mode to the detailed data acquisition mode (more precisely, in a case where communication using the Internet 360 is performed). The communication method field 1040 sets information designating which communication path is used and what communication protocol is used. A specific communication method may be described, or only information designating the communication mode set in the terminal apparatus 200 may be described.

The terminal apparatus 200 that has received the instruction to change from the normal mode to the detailed data acquisition mode transmits device data 1100 to the information management apparatus 100 through the relay device 330 and the Internet 360. That is, the device data 1100, which is more data than transmission data 500 transmitted in the normal mode, is transmitted.

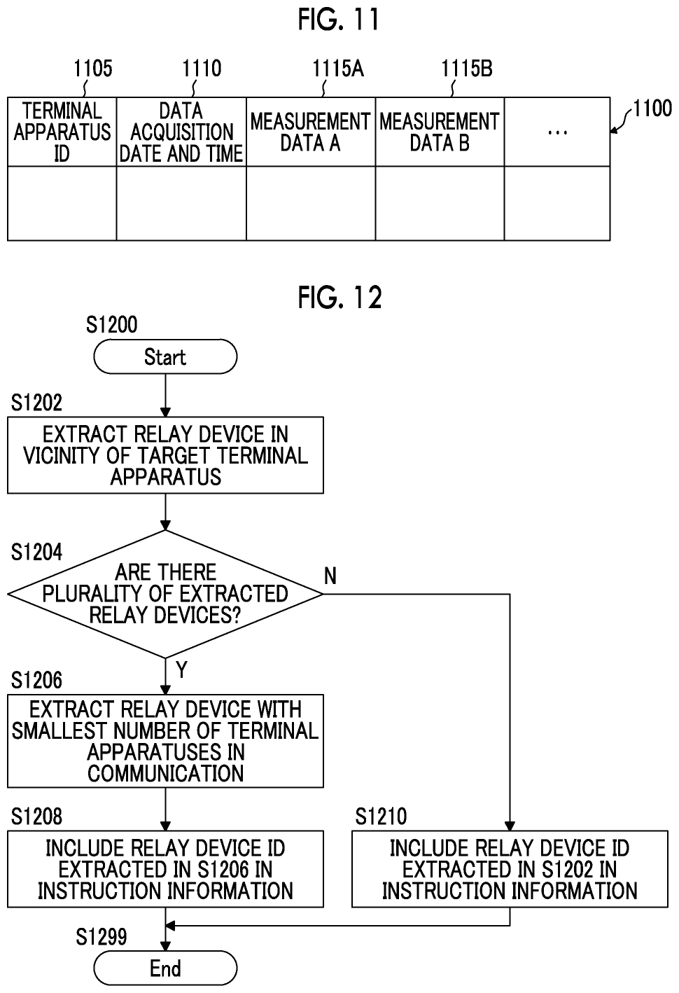

FIG. 11 is an explanatory diagram showing a data structure example of the device data 1100. The device data 1100 includes a terminal apparatus ID field 1105, a data acquisition date and time field 1110, a measurement data A field 1115A, a measurement data B field 1115B, and the like. The terminal apparatus ID field 1105 stores the terminal apparatus ID. The data acquisition date and time field 1110 stores the date and time when the data is measured. The measurement data A field 1115A stores measurement data A. The measurement data B field 1115B stores measurement data B. That is, data of the type designated in the information type field 1015 of the instruction information table 1000 is transmitted. The data acquisition date and time field 1110 may be provided for each individual measurement data.

A setting process example of the relay device ID field 1030 of the instruction information table 1000 transmitted in step S412 will be described.

FIG. 12 is a flowchart illustrating a process example according to the present exemplary embodiment.

In step S1202, the relay device 330 in the vicinity of the target terminal apparatus 200 is extracted. The relay device 330 may be extracted using the terminal apparatus-position correspondence table 800 and the relay device-position correspondence table 1300.

In step S1204, it is determined whether there are a plurality of extracted relay devices 330. In a case where there are a plurality of relay devices 330, the process proceeds to step S1206. Otherwise, the process proceeds to step S1210.

In step S1206, the relay device 330 with the smallest number of terminal apparatuses 200 in communication is extracted. The extraction is performed for designating the relay device 330 with a low load of relay processing. Specifically, the extraction may be performed using the relay device-terminal apparatus pair management table 1400.

In step S1208, the relay device ID of relay device 330 extracted in step S1206 is included in the instruction information.

In step S1210, the relay device ID of relay device 330 extracted in step S1202 is included in the instruction information.

In steps S1208 and S1210, specifically, the relay device ID may be set in the relay device ID field 1030 of the instruction information table 1000.

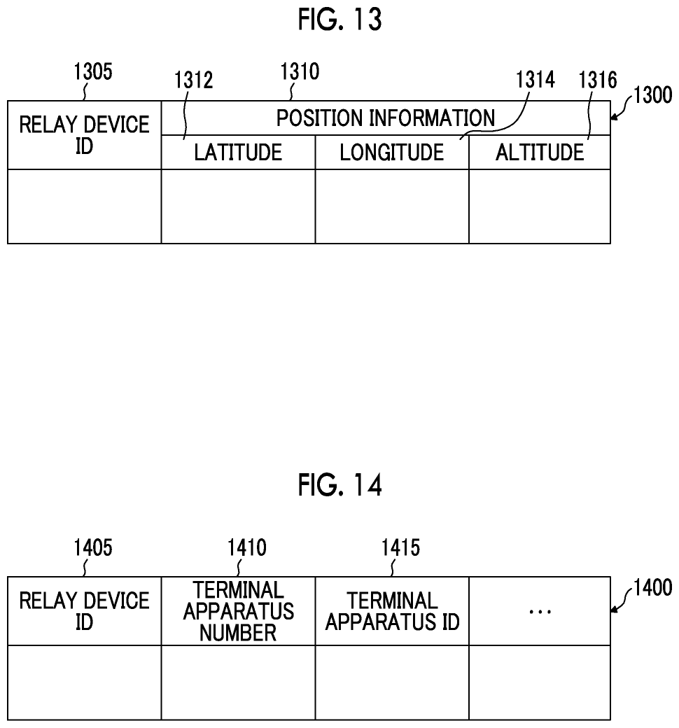

FIG. 13 is an explanatory diagram showing a data structure example of the relay device-position correspondence table 1300. The relay device 330 is also managed using a table similar to the terminal apparatus-position correspondence table 800. Specifically, the terminal apparatus ID field 805 of the terminal apparatus-position correspondence table 800 is set as the relay device ID.

The relay device-position correspondence table 1300 includes a relay device ID field 1305 and a position information field 1310. The position information field 1310 includes a latitude field 1312, a longitude field 1314, and an altitude field 1316. The relay device ID field 1305 stores the relay device ID. The position information field 1310 stores position information of the relay device 330. The latitude field 1312 stores latitude. The longitude field 1314 stores longitude. The altitude field 1316 stores the altitude. Since the relay device 330 is often fixed, the relay device-position correspondence table 1300 may be generated when the relay device 330 is installed.

In step S1206, the relay device-terminal apparatus pair management table 1400 is used to extract the number of terminal apparatuses 200 that are communicating.

FIG. 14 is an explanatory diagram showing a data structure example of the relay device-terminal apparatus pair management table 1400. The relay device-terminal apparatus pair management table 1400 has a relay device ID field 1405, a terminal apparatus number field 1410, a terminal apparatus ID field 1415, and the like. The relay device ID field 1405 stores the relay device ID of the relay device 330. The terminal apparatus number field 1410 stores the number of terminal apparatuses 200 connected to the relay device 330 by the near field communication 340. The terminal apparatus ID field 1415 stores the terminal apparatus ID of the terminal apparatus 200 connected to the relay device 330.

A process example of step S410 will be described.

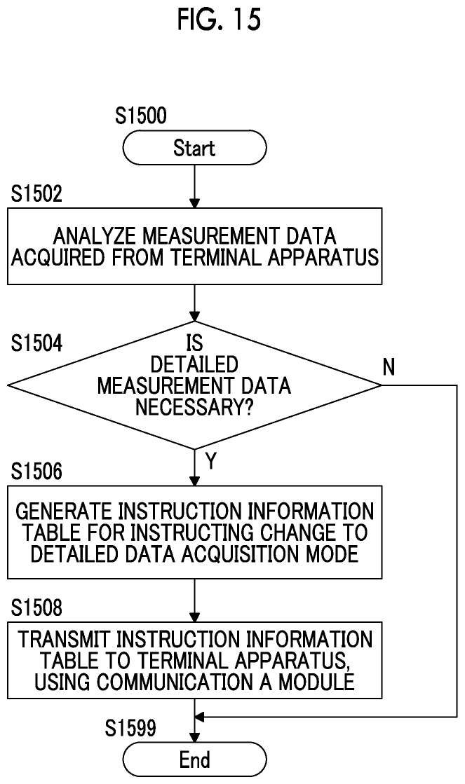

FIG. 15 is a flowchart illustrating a process example according to the present exemplary embodiment.

In step S1502, the measurement data acquired from the terminal apparatus 200 is analyzed.

In step S1504, it is determined whether detailed measurement data is necessary. In a case where it is necessary, the process proceeds to step S1506, and otherwise, the process ends (step S1599).

In step S1506, an instruction information table 1000 for instructing the change to the detailed data acquisition mode is generated. Specifically, an instruction to change from the normal mode to the detailed data acquisition mode is set in the instruction field 1010 of the instruction information table 1000. In addition, the information type field 1015 and the like are set.

In step S1508, the instruction information table 1000 is transmitted to the terminal apparatus 200, using the communication A module 105.

For example, the following processing is performed as processing of steps S1502 and S1504.

(1) In a case where the measurement data acquired from the terminal apparatus 200 is compared with a predetermined threshold and is an abnormal value, it is determined that more detailed measurement data than the measurement data acquired so far is necessary.
(2) In a case where the time-series measurement data group acquired from the terminal apparatus 200 is an abnormal pattern as compared with a predetermined pattern, it is determined that more detailed measurement data than the measurement data acquired so far is necessary.
(3) The transmission amount of the terminal apparatus 200 is acquired, and in a case where the transmission amount is greater than or equal to a predetermined threshold, it is determined that detailed measurement data is necessary. This is mainly intended to change the communication method.

A process example of step S432 will be described.

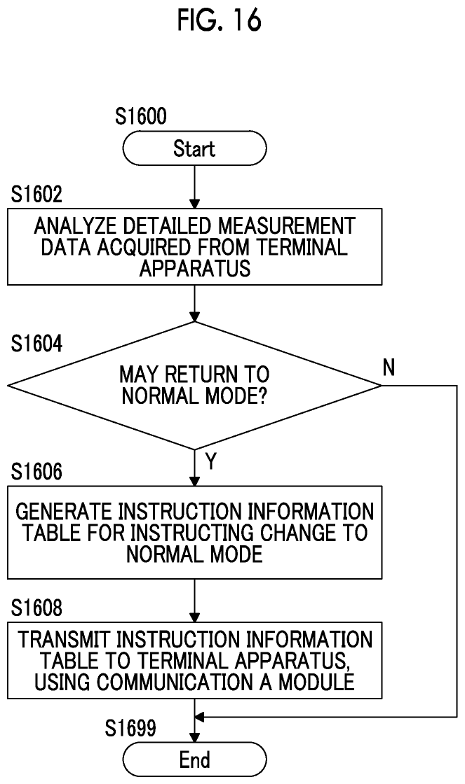

FIG. 16 is a flowchart illustrating a process example according to the present exemplary embodiment.

In step S1602, the detailed measurement data acquired from the terminal apparatus 200 is analyzed.

In step S1604, it is determined whether or not the process may return to the normal mode. In a case where the process may be returned, the process proceeds to step S1606, and otherwise, the process ends (step S1699).

In step S1606, the instruction information table 1000 for instructing the change to the normal mode is generated. Specifically, an instruction to change from the detailed data acquisition mode to the normal mode is set in the instruction field 1010 of the instruction information table 1000. In addition, the information type field 1015, the communication method field 1040, and the like may be set. In a case of an instruction to change to the normal mode, it may be returned to the initial state (so-called initialization).

In step S1608, the communication A module 105 is used to transmit the instruction information table 1000 to the terminal apparatus 200.

### Modification Example 1

As the second communication method, a communication method having a larger data amount and a wider communication bandwidth than the LPWA communication 320 through the base station 310 may be adopted.

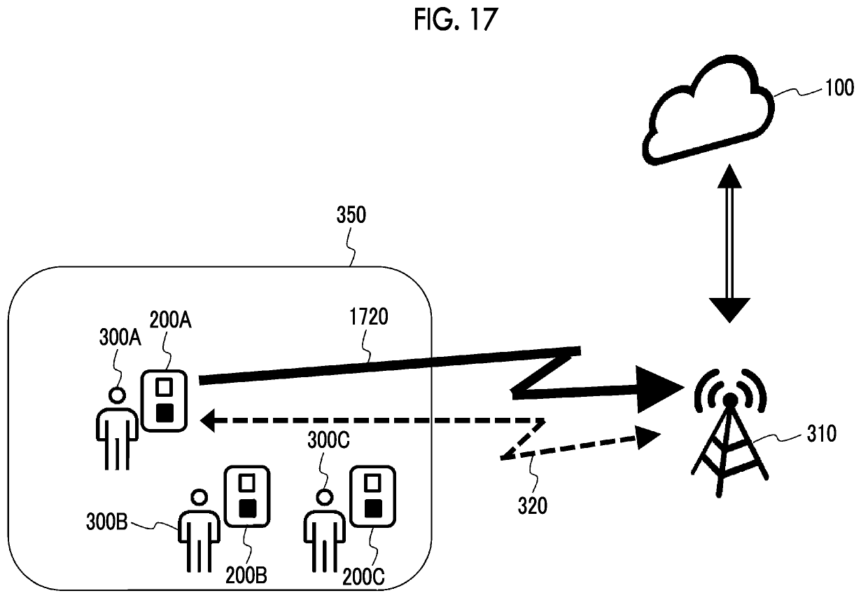

This will be described using an example shown in FIG. 17. FIG. 17 is an explanatory diagram showing a process example using Modification Example 1 of the present exemplary embodiment.

In a case of changing from the normal mode to the detailed data acquisition mode, the information management apparatus 100 performs the following processing.

(1) As a second communication method, communication using a public line of mobile phone communication 1720 is permitted.
(2) Instructing the target terminal apparatus 200 to transmit the data acquired in the detailed data acquisition mode, using the mobile phone communication 1720, through the first communication method.

This processing is performed by the information management apparatus 100 when it is determined that detailed data immediately is to be acquired immediately by mobile phone communication 1720, even at the cost of communication.

Note that, the mobile phone communication 1720 is communication that excludes the LPWA communication 320, has a larger capacity than the LPWA communication 320, and uses “user plane” of voice data and packet data.

This will be described in more detail.

The information management apparatus 100 manages the user 300 and usage contract information related to the line with which the user 300 is contracted. When the information management apparatus 100 determines that regarding the data acquired from the terminal apparatus 200, the operation of the terminal apparatus 200 is to be changed from the normal mode to the detailed data acquisition mode, based on the predetermined condition, the information management apparatus 100 gives an instruction to change to the detailed data acquisition mode, and to change to the mobile phone communication 1720 using the public line of the mobile phone, as the communication method B.

This determination is made only in a case where the information management apparatus 100 can use a large-capacity and high-speed mobile phone, based on the usage contract information related to the line contracted by the user 300, although the communication cost is higher.

In a case where the communication method A is the LPWA communication 320, power consumption is low or data capacity for communication is small, so a communication bandwidth is narrow, and cost is low. However, in a case where the data acquired from the terminal apparatus 200 exceeds a predetermined threshold, or changes in a predetermined pattern, when it is determined that more detailed data is to be acquired, the terminal apparatus 200 is instructed by using the communication method A so as to use communication means as the communication method B having a larger capacity and a higher-speed than the communication method A (mobile phone communication 1720 in the example of FIG. 17).

The communication method B may be communication through the same base station 310 as the communication method A, but is communication on a public line of a mobile phone having a larger capacity and higher speed. When the communication method A is NIDD, the terminal apparatus 200 transmits the acquired data to the information management apparatus 100 through the base station 310 using the user plane.

### Modification Example 2

As the second communication method, a communication method having a larger data amount and a wider communication bandwidth than the LPWA communication 320 through the base station 310 may be adopted.

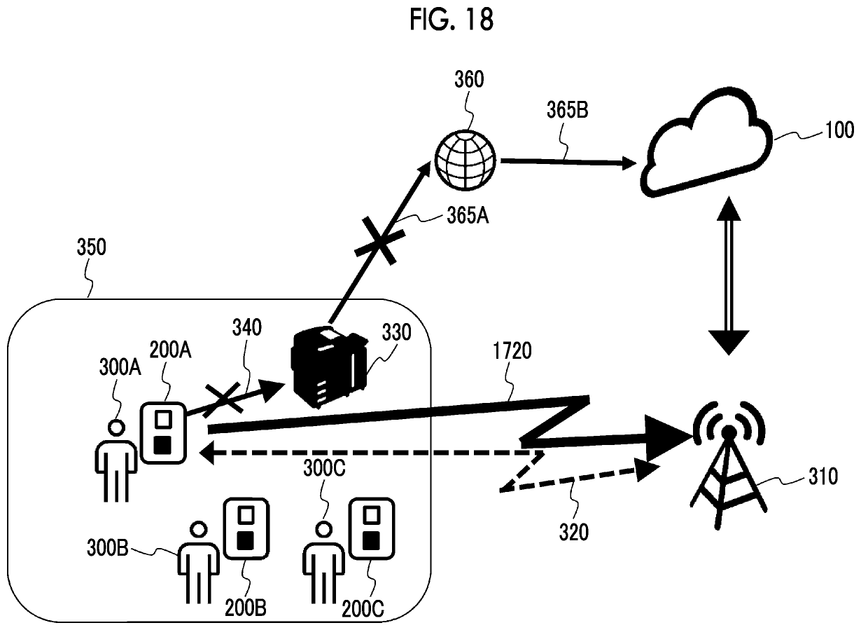

This will be described using an example shown in FIG. 18. FIG. 18 is an explanatory diagram showing a process example using Modification Example 2 of the present exemplary embodiment.

In a case of changing from the normal mode to the detailed data acquisition mode, the information management apparatus 100 performs the following processing. Note that, the change to the detailed data acquisition mode is performed, in a case where transmission is instructed through the relay device 330 as a second communication method, but reception cannot be performed.

(1) As a second communication method, communication using a public line of mobile phone communication 1720 is permitted.
(2) Instructing the target terminal apparatus 200 to transmit the data acquired in the detailed data acquisition mode, using the mobile phone communication 1720, through the first communication method.

This will be described in more detail.

After transmitting, to the terminal apparatus 200, the instruction to change to the detailed data acquisition mode and the communication method B, in a case where the information management apparatus 100 has not received data using communication method B even after a predetermined time has elapsed, or in a case where the information management apparatus 100 has received a notification from the terminal apparatus 200 that communication using the communication method B cannot be performed, because the relay device 330 does not exist near the terminal apparatus 200 or connection with the relay device 330 has failed, the information management apparatus 100 gives an instruction to change to communication using the public line of the mobile phone, as the second communication method B. The “notification from the terminal apparatus 200 that communication using the communication method B cannot be performed” is performed by communication using the LPWA communication 320.

This determination is made only in a case where the information management apparatus 100 can use a large-capacity and high-speed mobile phone, based on the usage contract information related to the line contracted by the user 300, although the cost is higher.

In a case where the communication method A is the LPWA communication 320, power consumption is low or data capacity for communication is small, so a communication bandwidth is narrow, and cost is low. However, in a case where the data acquired from the terminal apparatus 200 exceeds a predetermined threshold, or changes in a predetermined pattern, when it is determined that more detailed data is to be acquired, the terminal apparatus 200 is instructed by using the communication method A so as to use communication means as the communication method B having a larger capacity and a higher-speed than the communication method A. Note that, the high-speed communication means in the instruction here is communication by the Internet communication 365 through the relay device 330. In a case where the data cannot be received from the terminal apparatus 200 by “communication by the Internet communication 365 through the relay device 330” despite the instruction, it is instructed to perform communication using the mobile phone communication 1720 as the communication method B. Needless to say, this instruction is performed by communication using the LPWA communication 320.

The communication method B may be communication through the same base station 310 as the communication method A, but is communication on a public line of a mobile phone having a larger capacity and higher speed. When the communication method A is NIDD, the terminal apparatus 200 transmits the acquired data to the information management apparatus 100 through the base station 310 using the user plane.

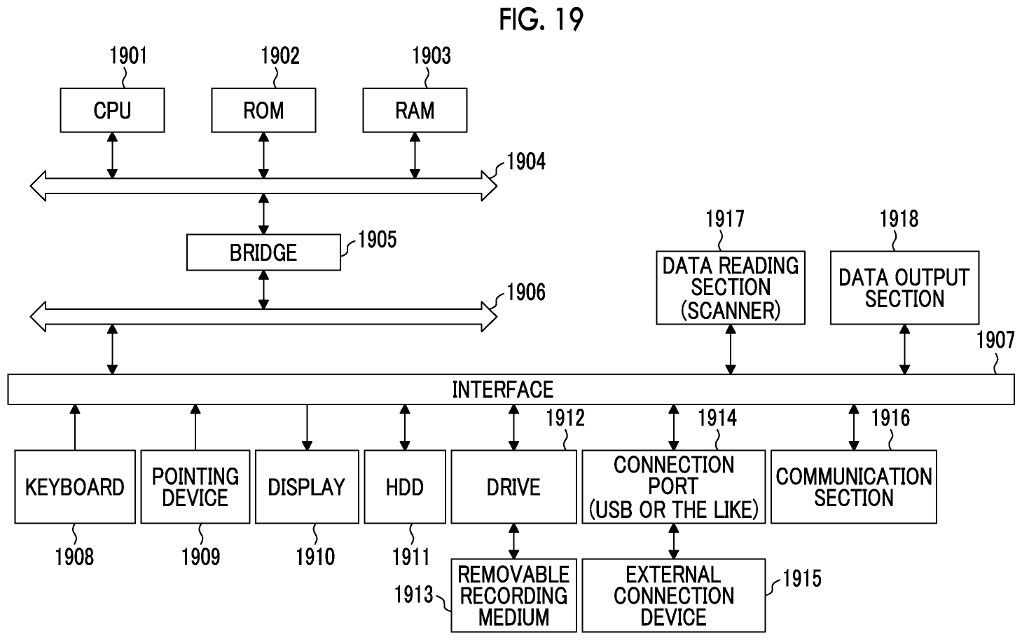

A hardware configuration example of the relay device 330 according to the present exemplary embodiment will be described with reference to FIG. 19. The configuration shown in FIG. 19 is, for example, the configuration of a personal computer or the like, and shows an example of a hardware configuration including a data reading section 1917 such as a scanner and a data output section 1918 such as a printer.

A CPU (abbreviation of Central Processing Unit) 1901 is a control unit that executes a process according to the computer program describing various modules described in the above-described exemplary embodiment, that is, the execution sequences for performing the function of the relay device 330.

A ROM (abbreviation of Read Only Memory) 1902 stores programs, operation parameters, and the like used by CPU 1901. A RAM (abbreviation of Random Access Memory) 1903 stores programs to be used in the execution of CPU 1901, parameters appropriately changed in the execution thereof, and the like. These are mutually connected by host bus 1904 which is a CPU bus or the like.

The host bus 1904 is connected to an external bus 1906 such as a PCI (abbreviation of peripheral component interconnect/interface) bus, through a bridge 1905.

A keyboard 1908 and a pointing device 1909 such as a mouse are devices operated by an operator. A display 1910 is a liquid crystal display device or a CRT (abbreviation of cathode ray tube) and the like, and displays various types of information as text or image information. It may be a touch screen or the like having both functions of a pointing device 1909 and a display 1910. In that case, with respect to realization of the function of the keyboard, the function of the keyboard may be realized by drawing keyboard (so-called software keyboard, screen keyboard or the like) by software on the screen (for example, touch screen) without physical connection as the keyboard 1908.

A hard disk drive (HDD) 1911 incorporates a hard disk (which may be a flash memory or the like in addition to the hard disk), drives the hard disk, and records or plays back programs and information to be executed by CPU 1901. Various data for communication as the relay device 330, various computer programs, and the like are stored.

The drive 1912 reads data or a program recorded on removable recording medium 1913 such as a mounted magnetic disk, optical disk, magneto-optical disk, semiconductor memory or the like, and supplies the data or program to RAM 1903 connected through interface 1907, external bus 1906, bridge 1905, and host bus 1904. A removable recording medium 1913 can also be used as a data recording area.

The connection port 1914 is a port to which the external connection device 1915 is connected, and has a connection portion such as USB and IEEE 1394. The connection port 1914 is connected to the CPU 1901 and the like through the interface 1907, the external bus 1906, the bridge 1905, the host bus 1904, and the like. The communication section 1916 is connected to a communication line and executes a data communication process with the outside. Specifically, pair establishment and communication by the near field communication 340 with the terminal apparatus 200, and communication with the information management apparatus 100 through the Internet 360 are performed. The data reading section 1917 is, for example, a scanner, and executes a document reading process. The data output section 1918 is, for example, a printer, and executes a document data output process.

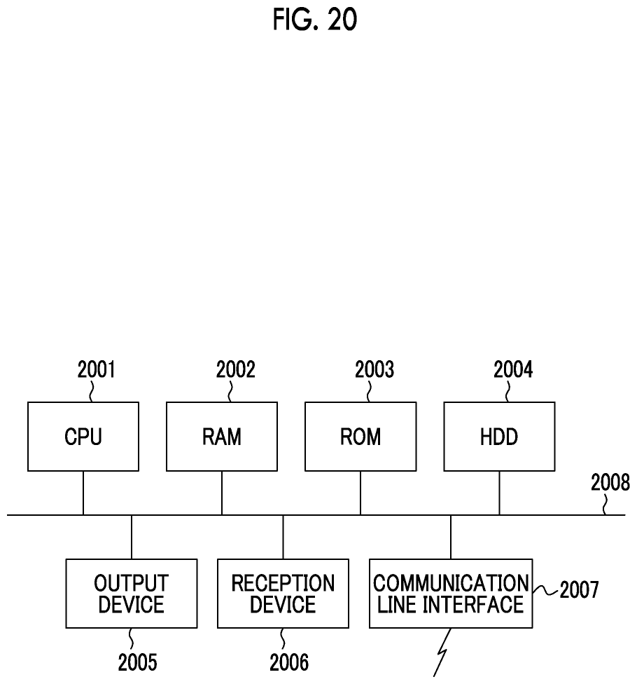

As illustrated in FIG. 20, the hardware configuration of the computer on which the program as the information management apparatus 100 which is the present exemplary embodiment is executed is a general computer, specifically, a computer that can be a personal computer, a server, or the like. In other words, as a specific example, a CPU 2001 is used as a processing unit (calculation unit), and a RAM 2002, a ROM 2003, and an HDD 2004 are used as a storage device. As the HDD 2004, for example, an HDD (abbreviation for Hard Disk Drive), an SSD (abbreviation for a solid state drive) that is a flash memory, or the like may be used. The computer includes the CPU 2001 executing programs for the communication A module 105, the communication B module 110, the data acquisition A module 115, the data acquisition B module 120, the storage control module 125, and the instruction transmission module 135, the RAM 2002 storing the programs or data, the ROM 2003 storing a program or the like for activating the computer, the HDD 2004 which is an auxiliary storage device having a function as the storage module 130 or the like, a reception device 2006 that receives data based on an operation (including an action, a voice, a line of vision, and the like) of the user on a keyboard, a mouse, a touch screen, a microphone, or a camera (including a visual line detection camera or the like), an output device 2005 such as a CRT, a liquid crystal display, or a speaker, a communication line interface 2007 for a connection to a communication network, such as a network interface card, and a bus 2008 connecting the above-described components to each other in order to transmit and receive data. Such a plurality of computers may be connected to each other via a network.

Among the above-described exemplary embodiments, in a case of the embodiment based on a computer program, the computer program which is software is read to a system having the present hardware configuration, and the exemplary embodiment is realized through cooperation between the software and the hardware resources.

The hardware configuration illustrated in FIGS. 19 and 20 corresponds to one configuration example, and the present exemplary embodiment is not limited to the configuration illustrated in FIGS. 19 and 20, and any configuration in which the modules described in the present exemplary embodiment can be executed may be used. For example, some of the modules may be configured with dedicated hardware (for example, an application specific integrated circuit (ASIC) or a field-programmable gate array (FPGA)), some of the modules may be provided in an external system, and may be connected to a communication line, and such a plurality of systems illustrated in FIGS. 19 and 20 may be connected to each other via a communication line so as to operate in cooperation therebetween. Further, in addition to personal computers, in particular, it may be cooperated into portable information communication devices (including mobile phones, smartphones, mobile devices, wearable computers, or the like), information appliances, robots, copiers, faxes, scanners, printers, multifunction peripherals, and the like.

The program may be stored on a recording medium so as to be provided, and the program may be provided by using communication means. In this case, for example, the program may be understood as the invention of a “non-transitory computer readable medium storing the program”.

The “non-transitory computer readable medium storing the program” indicates a computer readable recording medium storing the program, used to install, execute, and distribute the program.

Examples of the recording medium include “DVD-R, DVD-RW, and DVD-RAM” which is for a digital versatile disc (DVD) and is a standard established by the DVD Forum and “DVD+R and DVD+RW” which is a standard established by DVD+RW, a read-only memory (CD-ROM), CD recordable (CD-R), and CD rewritable (CD-RW) being for a compact disc (CD); Blu-ray (registered trademark) discs; a magneto-optical disk (MO), a flexible disk (FD), a magnetic tape, a hard disk, a read-only memory (ROM), an electrically erasable programmable read-only memory (EEPROM (registered trademark)), a flash memory, a random access memory (RAM), and a secure digital (SD) memory card.

The whole or a part of the program may be recorded on the recording medium so as to be preserved or distributed. The program may be transmitted through communication, for example, by using a wired network used for a local area network (LAN), a metropolitan area network (MAN), a wide area network (WAN), the Internet, an intranet, or an extranet, a wireless communication network, or a combination thereof, and may be carried via a carrier wave mounted therewith.

The program may be a part of the whole of another program, or may be recorded on a recording medium along with a separate program. The program may be divided and recorded on a plurality of recording media. The program may be recorded in any restorable aspect such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information management apparatus comprising:
a storage unit that stores identification information of a terminal apparatus and data acquired from the terminal apparatus in association with each other;
a first communication unit that communicates with the terminal apparatus by a first communication method for transmitting and receiving data through a base station of a mobile phone communication network;
a second communication unit that performs communication by a second communication method having a larger amount of data communicable than the first communication method;
a first data acquisition unit that acquires, from the terminal apparatus, data including first data acquired by the terminal apparatus and the identification information of the terminal apparatus, using the first communication unit; and
an instruction transmission unit that transmits to the terminal apparatus, an instruction to transmit the data using the second communication method, in a case where a change occurs in the first data acquired by the first data acquisition unit.

2. The information management apparatus according to claim 1,
wherein, out of a first data area that is a fixed-length data area used in a communication procedure in mobile phone communication between the terminal apparatus and the base station of the mobile phone communication network, and a second data area that is used in data communication after communication is established in the communication procedure, and is a variable-length data area corresponding to data transmitted, data acquired by the terminal apparatus is included in the first data area, and the first communication unit transmits and receives data through the base station using the first communication method for transmitting and receiving data only in the first data area.

3. The information management apparatus according to claim 1,
wherein the communication unit performs communication with a relay device through the Internet, wherein the relay device is connected to a communication line protected by a firewall.

4. The information management apparatus according to claim 1,
wherein second data has a larger data amount than the first data, and
wherein the instruction transmission unit transmits instruction information, in a case where it is necessary to acquire more detailed data than the first data.

5. The information management apparatus according to claim 4,
wherein the instruction information includes information indicating a type of information to be acquired by the terminal apparatus.

6. The information management apparatus according to claim 5,
wherein the instruction information includes information indicating a type different from the type, in addition to the type of information included in the first data.

7. The information management apparatus according to claim 4,
wherein the instruction information includes information indicating a data acquisition interval.

8. The information management apparatus according to claim 4,
wherein the instruction information includes information indicating a data transmission interval.

9. The information management apparatus according to claim 4,
wherein the instruction transmission unit transmits the instruction information, in a case where the first data acquired by the first data acquisition unit changes under a predetermined condition.

10. The information management apparatus according to claim 9, further comprising:
a second data acquisition unit that acquires data including second data acquired by the terminal apparatus and the identification information of the terminal apparatus, from the terminal apparatus connected to a communication line protected by a firewall, using the second communication unit,
wherein in a case where the second data acquired by the second data acquisition unit no longer meets the predetermined condition, the instruction transmission unit transmits change information for changing from communication through the relay device to communication through the base station.

11. The information management apparatus according to claim 9,
wherein the condition is a case where an acquisition interval of the first data by the first data acquisition unit is longer than a previous acquisition interval.

12. The information management apparatus according to claim 1, further comprising:
a second data acquisition unit that acquires data including second data acquired by the terminal apparatus and the identification information of the terminal apparatus, from the terminal apparatus connected to a communication line protected by a firewall, using the second communication unit; and
a notification unit that notifies the user corresponding to the identification information of the terminal apparatus, in a case where acquisition of the second data by the second data acquisition unit is impossible,
wherein the storage unit stores the identification information and information on the user of the terminal apparatus in association with each other.

13. The information management apparatus according to claim 12,
wherein in a case of receiving information from the terminal apparatus that communication through the relay device is impossible, the notification unit notifies the user corresponding to the identification information of the terminal apparatus.

14. A terminal apparatus comprising:
data handled in mobile phone communication between a terminal apparatus and a base station of a mobile phone communication network having at least two or more areas, a first data area out of the two areas having a smaller data amount than a second data area which is another area, data acquired by the terminal apparatus being included in the first data area,
a third communication unit that transmits and receives data to and from an information management apparatus outside a firewall through the base station using a communication method for transmitting and receiving data only in the first data area;
a fourth communication unit that performs near field communication with a relay device inside of the firewall;
a third data acquisition unit that acquires data;
a fourth data acquisition unit that acquires more data than the data acquired by the third data acquisition unit; and
a control unit that performs control such that the data acquired by the third data acquisition unit is transmitted to the information management apparatus by using the third communication unit, and in a case where the third communication unit receives instruction information for instructing to perform communication through the relay device from communication through the base station, the data acquired by the fourth data acquisition unit is transmitted to the information management apparatus by using the fourth communication unit.

15. An information management apparatus comprising:
storage means for storing identification information of a terminal apparatus and data acquired from the terminal apparatus in association with each other;
first communication means for communicating with the terminal apparatus by a first communication method for transmitting and receiving data through a base station of a mobile phone communication network;
second communication means for performing communication by a second communication method having a larger amount of data communicable than the first communication means;
first data acquisition means for acquiring, from the terminal apparatus, data including first data acquired by the terminal apparatus and the identification information of the terminal apparatus, using the first communication means; and
instruction transmission means for transmitting to the terminal apparatus, an instruction to transmit the data using the second communication method, in a case where a change occurs in the first data acquired by the first data acquisition means.
